(19) United States
(12) Patent Application Publication
(10) Pub. No.: US 2025/0037390 A1
(43) Pub. Date: Jan. 30, 2025

(54) System, Device and Method for Presenting Video Content

(71) Applicant: Sheryl Turner, Malibu, CA (US)

(72) Inventor: Sheryl Turner, Malibu, CA (US)

(21) Appl. No.: 18/786,491

(22) Filed: Jul. 27, 2024

Related U.S. Application Data
(60) Provisional application No. 63/529,142, filed on Jul. 27, 2023.

(51) Int. Cl. G06T 19/00; G06K 7/14; G06T 19/20; H04N 19/136

(52) U.S. Cl. CPC G06T 19/006; G06K 7/1413; G06K 7/1417; G06T 19/20; G06T 2210/32; G06T 2219/2016; G06T 2219/2021; H04N 19/136

(57) ABSTRACT

A system, device, and method for associating a video with a still image, and for presenting the video to a user in an augmented reality when the user is viewing the still image via the user's smart phone camera.

### CROSS REFERENCE TO RELATED APPLICATIONS

The current application claims priority from U.S. Provisional Patent Application No. 63/529,142, filed Jul. 27, 2023 and entitled “System, Device, and Method for Presenting Video Content,” the entire contents of which are incorporated herein by reference.

### FIELD OF THE INVENTION

The present invention relates to mobile devices and software. More specifically, it relates to preparing and displaying content on a mobile electronic device.

### BACKGROUND OF THE INVENTION

Still images, such as printed photos, paintings, graphics, sculptures, brochures, etc. are well known in the art. Videos are also well known in the art, and can be stored in various formats.

There is a need for improved presentation of still and video images, including presentations in virtual/augmented reality. The current invention fulfils these needs.

### SUMMARY OF THE INVENTION

The present invention provides systems, devices, and methods for associating videos with still physical images, and for displaying the associated videos to users in a virtual/augmented reality via a portable electronic device such as a smart phone, tablet, mixed reality glasses/headsets, etc.

Embodiments of the invention may comprise associating a scannable code (such a generated code (e.g., QR or bar code) or another “code”) with a physical image (e.g., printed image, painting, photograph, etc.). Note that the physical image itself (e.g., a portion thereof) may function as a scannable “code” recognized by the system, such as via image recognition. If a QR/bar code is involved, that generated code may be printed out and secured to or adjacent the painting/photograph. A video is selected by a user to be associated, via the scannable code, with the particular painting/photograph. The scannable code info and association with the particular video is stored, along with the selected video, in a remote server (and/or in the smart phone). When a dedicated app of the electronic device (e.g., smart phone) recognizes the scannable code (e.g., when the smart phone camera is directed at the painting/photograph and scannable code), the electronic device directs scannable code information to a remoter server. The remote server recognizes the scannable code information, identifies the selected video, and transmits (downloads) the selected video to the smart phone. The smart phone (via the camera and app) presents a live video of the painting/photograph as taken by the smart phone camera, but overlays the selected video onto the still image of the painting/photograph that would otherwise appear on the smart phone screen. The selected video is played, which may include movement as well as audio, while overlaid onto the camera-generated view of the painting/photograph appearing on the smart phone screen.

Embodiments of the invention allow users to quickly and easily link a video to a physical image/item (e.g., photo, graphic, etc.), and allows other users to quickly access such videos.

Examples of physical images/items that can be associated with a scannable code (and overlaid by an associated video) include paintings, printed photographs, images, graphics, photo albums, scrapbooks, awards, movie posters, magazines, museum galleries/exhibitions, sculptures, greeting cards, invitations, calendars, t-shirts, flyers, brochures, business cards, memorabilia, record/LP covers, sports programs and other event programs, playing cards, yearbooks, memory books, gift merchandise (e.g., mugs, magnets, photo tiles), book covers, book pages, etc.

It should be understood that each of the elements disclosed herein can be used with any and all of the elements disclosed herein, even though the specific combination of elements may not be explicitly shown in the figures herein. In other words, based on the explanation of the particular device, one of skill in the art should have little trouble combining the features of certain of two such devices. Therefore, it should be understood that many of the elements are interchangeable, and the invention covers all permutations thereof.

Other objects, features, and advantages of the present invention will become apparent from a consideration of the following detailed description.

### BRIEF DESCRIPTION OF THE DRAWINGS

FIG. 1 is a view of a system according to an embodiment of the invention;

FIG. 2 depicts a flow chart of a process according to an embodiment of the invention;

FIG. 3 depicts a flow chart of a process according to an embodiment of the invention;

FIGS. 4A-4C depict screen views of the smart phone according to embodiments of the invention;

FIG. 5 depicts a flow chart of a process according to an embodiment of the invention; and

FIG. 6 depicts a view of a system according to an embodiment of the invention.

### DETAILED DESCRIPTION OF SEVERAL EMBODIMENTS

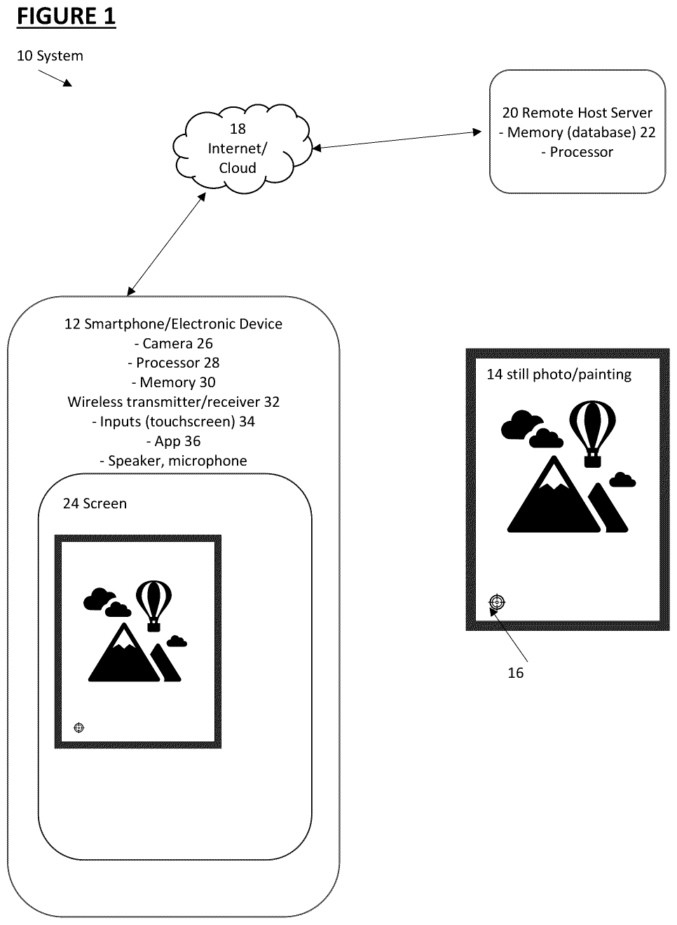

FIG. 1 illustrates a system 10 according to the present invention for presenting videos and still images in a virtual reality format via a camera-equipped smart electronic device such as a smart phone, etc. An electronic device in the form of a smart phone 12 is provided which can be held in the hand of a user. A physical image presentation 14 (such as a painting or still photo) is provided, such as by positioning the physical image presentation 14 (painting or still photo) in a scrapbook or in a picture frame or on a wall. A scannable code 16 such as a generated code (e.g., QR code) is positioned on or adjacent the physical image presentation 14. Note that the scannable code may be all or a portion of the physical image presentation 14 itself, which the system can recognize via image recognition. The smart phone 12 uses an internet connection 18 (such as via the cloud) to a remote server 20 having a database 22. A live video feed of the physical image 14 is provided on the smart phone screen 24 via the smart phone camera 26, with the live video feed including a depiction of the physical image 14 and/or an associated video overlaid on the physical image depiction.

A device according to an embodiment of the invention has the smart phone 12 comprising a smart phone screen 24, a smart phone camera 26, a smart phone processor 28, a smart phone memory 30, a smart phone wireless transmitter/receiver 32 (e.g., wireless, wi-fi, and/or Bluetooth, etc.). Input elements such as a touchscreen 34 or verbal input (via microphone) are used by a user to enter selections into the smart phone 12. A dedicated app 36 may be stored in the smart phone memory 30, with the app 36 adapted to be run via the smart phone processor 28. Videos played in overlay fashion on the screen (e.g., overlaid on the still image) may include sound delivered via smart phone speaker(s).

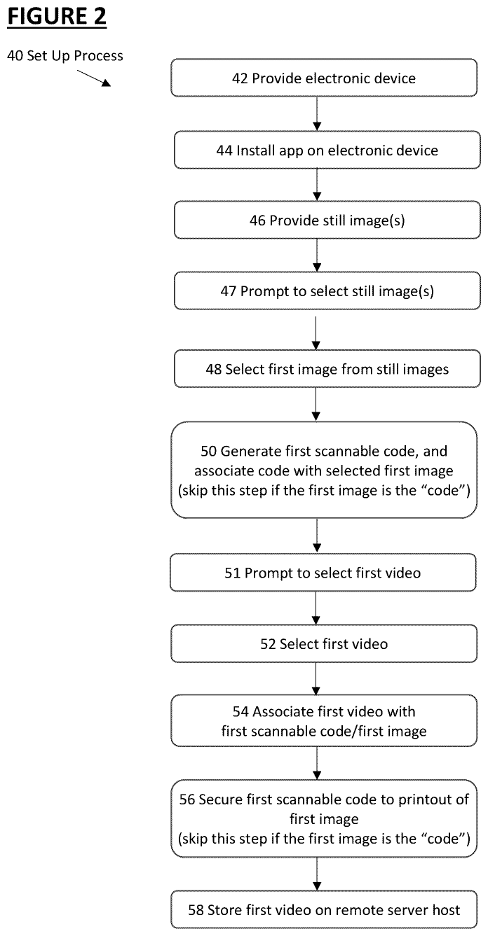

FIG. 2 depicts a set-up process 40 according to an embodiment of the invention. At 42, a portable electronic device (such as a smart phone) is provided. At 44, a specific app is provided/installed on the portable electronic device. At 46, one or more still images are provided, which may include storing the one or more still images in an internal memory of the electronic device. Note that the still images may be provided (e.g., stored on the electronic device) by the act of a user taking photos (e.g., taken directly via a camera of the electronic device, such as a smart phone camera) of a painting or other item desired to be imaged. At 47, a user is prompted (e.g., via the app/smart phone) to select a first image (such as an image obtained by the user with the smart phone camera) Note that if the image is obtained by the user via the smart phone camera, the step of taking providing the image 46 (e.g., taking the photo to create the image) may be combined with the step of selecting the first image 48 and with the prompting step 47 (with prompting asking whether user wishes to create a new image or select from existing images). At 48, a first image is selected from the one or more still images. Note that 48 may be performed via the app by a person who is controlling the set-up process. At 50, a first scannable code (such as a QR code, bar code, etc.) is generated (e.g., via the remote server), and the first scannable code is associated (e.g., via the app) with the first selected image. (Note that the first scannable code may be formed by the selected image itself, e.g., all or a portion of the selected image, in which case there is no need to generate a scannable code). At 51, a user is prompted (e.g., via the app/smart phone) to select a first video to be associated with the first selected image and/or first scannable code. (Note that the use may be prompted to create the first video (e.g., via the smart phone camera), or to select the first video from a selection of videos which may be provide by the host server and/or the smart phone.) At 52, a first video is selected (via the app, such as by input from the person controlling the set-up process). At 54, the first video is associated with the first image (which may be performed via the app), which may include associating the first video with the first scannable code of the first image. At 56, the first scannable code is secured on or adjacent a printout or other physical embodiment of the first image. Note that the user and/or the app may select the specific position of the scannable code on or adjacent the printout/physical image. The printout/overlay of the scannable code may also include an image of the name/mark of the host system, so that a user will know the significance of the printout/overlay and the app with which it can be used, etc. The scannable code may be electronically overlaid on the digital version of the selected image, with the selected image with scannable code thereon printed out for display. Alternatively, the scannable code can be physically applied to a physical/printed version of the first image, such as by printing out the scannable code and applying (e.g., via adhesive, etc.) the printed scannable code on or adjacent the physical/printed version the first image. Note that where the first image itself (e.g., all or a portion thereof) serves as the scannable code (e.g., via image recognition), the step 56 of securing the scannable code to the image is unnecessary because the “scannable code” is already an integral part of the first image. At 58, the first selected video is stored on a remote server host, which may include uploading the first selected video to the remote server host, and/or may include associating the first scannable code and/or first image with the first selected video. Note that the first selected video may be formatted to a desired format for storage on the remote server host. The remote server host may store and process multiple videos and information on the associated scannable codes, such as a catalog of videos with their corresponding scannable codes.

Note that the order one or more of the set-up process elements can be changed from the order depicted in FIG. 2 and still be within the scope of embodiments of the invention. For example, 56 securing the scannable code to the printout may be skipped (e.g., if the image itself serves as the scannable code) or may occur before or after or concurrently with 54 associating the first video with the first scannable code. Similarly, generating the first scannable code (51) may be skipped or may occur before or after or concurrently with selection (52) and/or uploading/storing (58) the first selected video to the remote server host. The image may be photographed and cropped and itself (e.g., all or a designated portion thereof) become a scannable code to be associated with the first video and used in a similar way to the scannable code.

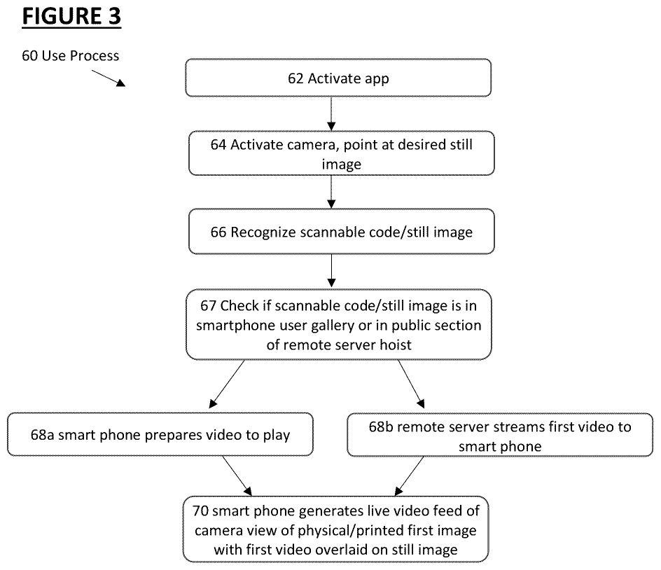

FIG. 3 depicts a use process 60 where a user can view the selected video in a desired virtual reality presentation on a smart phone or other electronic device. At 62, the specific app is activated on the smart phone or other electronic device. At 64, the smart phone camera is activated, and the user points the lens of the smart phone camera at the physical/printed version of the first image and the associated scannable code (or just at the image if the image itself is used as scannable code). At 66, the first scannable code/image is recognized (e.g., via the camera and/or app). A determination is made as to which particular video is associated with the particular scannable code/image, and the first scannable code/image info is sent to the local device and may also be sent to the remote server host. At 67, if the scannable code (e.g., image) is recognized on the local device, then the local device may determine which particular video is associated with the particular scannable code/image info or image. Otherwise, the first scannable code info is sent to the remote server host, and the remote server host determines which particular video is associated with the particular scannable code info. At 68a, if the smart phone has the video info already in smart phone memory, then the smart phone prepares the video to play. Otherwise, at 68b, the remote server host transmits (via internet, cell phone system, Wi-Fi, Bluetooth, etc.) the particular video to the smart phone. Note that the particular video may have been preloaded on the smart phone, either via download from the remote server host, download from other sources (e.g., the web), and/or directly taken/generated with the smart phone. At 70, the smart phone generates a live video feed of the camera-provided view of the physical/printed version of the first image, but with the particular video (associated with the scannable code) electronically/digitally overlaid (via the app) onto or adjacent the first image as depicted on the smart phone screen.

Note that generating the live video feed with associated video overlay 70 may include matching the size and shape of the overlay of the associated video with the size and shape of the still image as shown in the live video feed, which may give the impression of the still image “coming to life” when viewed on the modified live video feed (i.e., the video feed with the overlaid video). The size and shape of the associated video may be adjusted in real time in order to adjust for changes in the apparent size/shape of the first image when viewed on the smart phone screen that may be caused by movement of the smart phone camera with respect to the physical/printed version of the still image. For example, if the smart phone/camera is moved away from the physical/printed version of the still image, the size of the still image on the smart phone screen will be reduced, so that the app may reduce the corresponding size of the associated video in the overlay presentation to match the still image size. Similarly, if the smart phone/camera is moved up, down, or sideways with respect to the physical/printed version of the still image, the shape of the still image on the smart phone screen will be changed (e.g., distorted), so that the app may change the corresponding shape of the associated video to match the still image shape in the overlay presentation. Downward movement of the smart phone/camera with respect to the physical/printed version of the still image may cause the upper edge of the still image on the smart phone screen to be reduced in width with respect to the width of the lower edge of the still image, so a corresponding reduction in width of the upper edge of the first selected video may be performed to match the video shape to the still image shape.

Note that multiple videos can be associated with a particular still image and/or scannable code. Additionally or alternatively, a single video can be associated with multiple still images and/or scannable codes.

One or more videos (e.g., videos provided by the remote server host) may be retained in the memory of the electronic device, such as being retained after step 70 of FIG. 3 is performed. This may provide faster access to the video overlay process if the user wishes to revisit the image on which the video is overlaid, and/or provide the ability for the user to recreate the image overlay on the smart phone without having to physically revisit the physical/printed image (e.g., without having to revisit the art gallery in which a particular painting was shown). Such stored video overlay access may be provided in combination with advertising, such as where an advertiser pays for advertising to be associated with a particular image/video combination, and the user can only access that image/video in combination with advertising from the advertiser.

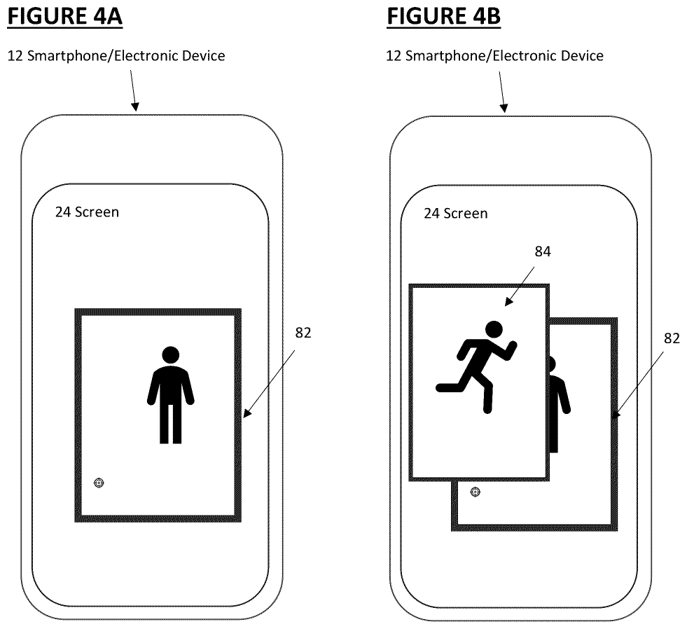

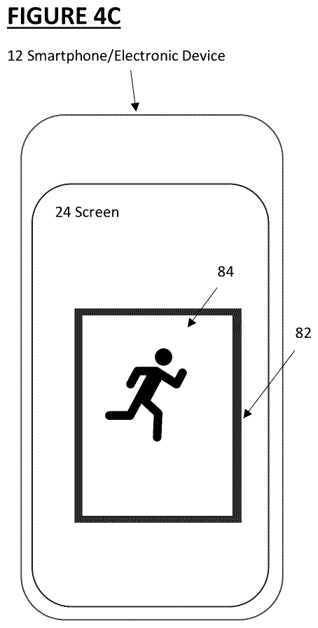

FIGS. 4A-4C depict smart phone screens and associated images/videos provided thereon using an app according to embodiments of the invention. FIG. 4A depicts a smart phone 12 with smart phone screen 24, with a live video feed 80 gathered by the smart phone camera and presented on the smart phone screen 24. The live video feed 80 includes an image 82 of the physical image presentation 14 (e.g., still photo printout), due to the physical image presentation being within the field of view of the camera (such as by having a human user point the camera at the physical image presentation).

FIG. 4B depicts the live video feed 80 modified (e.g., via the app and smart phone processor) to overlay a formatted first video 84 over the image 82 of the physical image presentation 14 as viewed on the smart phone screen 24. Note that the formatted first video 84 may include corresponding audio, which can be played via speaker(s) of the smart phone. The formatted first video 84 may be overlaid onto or adjacent the image 82 on the smart phone screen 24. The shape and size of the first video 84 can be modified in real time (such as via the app and smart phone processor). For example, if the shape and size of the image 82 changes as the smart phone camera is moved with respect to the physical image presentation of the image 82, corresponding changes to formatted first video 84 can be made, including maintaining the relative position and relative shape and relative size of the formatted first video 84 on the screen (e.g., where “relative” is “relative to the image 82”). The result is that the image 82 may appear to “come to life” as the first video 84 when viewed on the screen appears to be a part of the image 82 and/or surrounding area as viewed on the smart phone screen 24. Note that resizing and/or reshaping of the first video shape/size may preferably comprise stretching or shrinking the entirety of or portions of the first video, and/or cropping portions of the first video, etc.

FIG. 4C depicts a live video feed where a first video 84 is overlaid over the image 82 so that the shape and size of the first video 84 matches the shape and size of the image 82 on the smart phone screen 24. The shape and size of the first video 84 can be modified in real time (such as via the app and smart phone processor) to match the shape and size of the image 82 in real time as the smart phone camera is moved with respect to the physical image presentation. The result is that the image 82 may appear to “come to life” as the first video 84 takes the place of and assumes the shape of the image 82 as viewed on the smart phone screen 24. Note that resizing of the first video shape/size may preferably comprise stretching or shrinking the entirety of or portions of the first video, and/or cropping portions of the first video, etc.

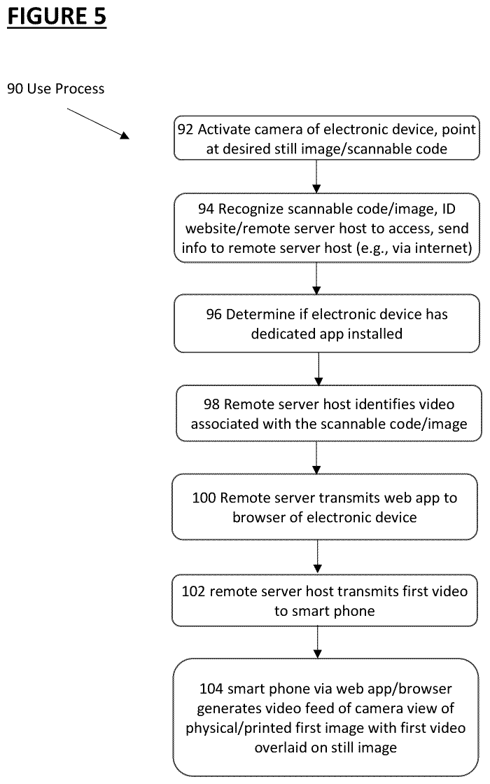

In other embodiments of the invention, the electronic device does not need a dedicated app but instead relies on the web browser to perform the overlay, etc. Such embodiments can use the same or similar setup process as depicted in FIG. 2. FIG. 5 depicts a use process 90 where a user can view the selected video in a desired virtual reality presentation on a smart phone or other electronic device. At 92, the smart phone camera is activated, and the user points the lens of the smart phone camera at the physical/printed version of the first image (and the associated generated scannable code, if included). At 94, the first scannable code/image is recognized (e.g., via standard smart phone protocols, image recognition, etc.), the remote server host address is recognized and accessed, and the first scannable code/image info is sent to the remote server host (such as via an internet connection). At 96, a determination may be made as to whether the electronic device has a dedicated app installed (such as the app discussed previously with respect to FIG. 3, etc.). If no dedicated app is detected, then the remote server provides a web browser app to the electronic device, at 98. (Note that if no dedicated app is detected, the user may be asked, e.g., via the electronic device through the browser and/or remote server, whether the user desires to install the dedicated app. If the user elects to download the dedicated app, then the operational aspects of FIG. 3 will be followed. Otherwise, FIG. 5 procedures will continue to apply.) At 100, the remote server host determines which particular video is associated with the particular scannable code info. At 102, the remote server host transmit the particular video to the electronic device. At 104, the electronic device-via the browser/web app-generates an augmented reality video by overlaying the first video (i.e., particular video associated with the image/scannable code) onto or adjacent the image as presented in the live video feed sent by the electronic device. The user views the generated augmented video on the electronic device screen.

Note that in the embodiments of FIG. 5, the overlay can be performed as discussed in prior embodiments, such as with the shape and size of the first video being adjusted in real time to correspond/match changes in the shape and size of the first image as seen on the display, etc.

Embodiments of the invention may include provision for advertising, which may be targeted to specific users and/or specific images and/or specific videos. Advertisements may be incorporated into the smart phone screen when the app is being used, with advertisements added onto still images, live video, overlay video, augmented reality, non-augmented reality, etc. screen images/videos of the smart phone.

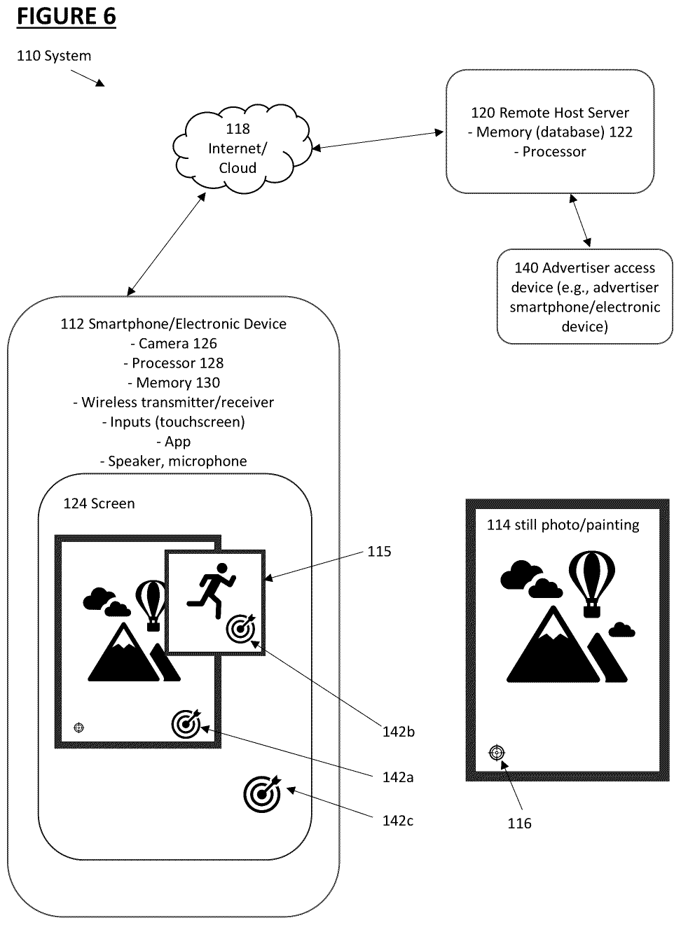

FIG. 6 illustrates a system 110 according to the present invention for presenting videos and still images with advertising elements in a virtual reality format via a camera-equipped smart electronic device such as a smart phone, etc. An electronic device in the form of a smart phone 112 is provided which can be held in the hand of a user. A physical image presentation 114 (such as a painting or still photo) is provided, such as by positioning the physical image presentation 114 (painting or still photo) in a scrapbook or in a picture frame or on a wall. A scannable code 116 such as a generated code (e.g., QR code) may be positioned on or adjacent the physical image presentation 114. Note that the scannable code may be all or a portion of the physical image presentation 114 which can be scanned and recognized via image recognition, in which case there is no need to create/position a specific generated code (e.g., QR code). The smart phone 112 uses an internet connection 118 (such as via the cloud) to a remote server 120 having a database 122. A live video feed of the physical image 114 is provided on the smart phone screen 124 via the smart phone camera 126, with the live video feed including a depiction of the physical image 114 and/or an associated video 115 overlaid on the physical image depiction.

Advertisers can access the system 110 via an electronic device 140 (such as a smart phone, laptop computer, etc.), which communicates with the remote host server 120. The advertiser can select advertising templates, upload advertising images/videos/graphics/etc., select advertising elements (e.g., colors, features, effects), etc., such as the examples listed above in paragraphs 0031-0047. Selected advertisements (e.g., videos, still images, products, logos, etc.) can be overlaid onto the augmented reality depicted on the screen 124 of the user's smartphone 112. For example, an advertisement 142a can be overlaid onto the still photo/painting 114 as viewed on the smart phone screen 124; an advertisement 142b can be included in the video overlay 115 added to the augmented reality view of the still photo/painting/image; an advertisement 142c can be inserted into the background scene as viewed on the smart phone screen 124.

Advertising options, such as those with the embodiment of FIG. 6, may include one or more of the following:
1. In-App Advertising Fees and Donations: Use of the app may be provided to a user (e.g., via the user's smart phone) for a fee. The fee may be charged for the use of the app at a particular venue; for the use of the app with a particular painting/display/image; for the use of the app at multiple venues and/or multiple images; etc. Note that the app fees may be different for different venues and/or different paintings/displays/images etc. Payment of app fees may entitle the user to use the app without advertising or with reduced advertising. Free or reduced-fee use of the app may be provided, but with advertising. Advertisements may relate to a specific venue and/or painting/display/image, such as where advertisements relate to a particular painting/display/image. Note that in lieu of or in addition to fees, the app may request donations when a user uses the app at a specific venue and/or to view specific paintings/displays/images, such as where a specific venue and/or specific painting/display/image relates to a particular cause. For example, a display of a whale-related painting may have a message associated therewith which relates to contributions to an organization that promote the protection of whales.
2. User-Generated Ads: Users may be given the option via the app to create their own advertisements with the augmented realities they create via the app. This allows for personalized and user-driven marketing content, enabling a more authentic and engaging advertising approach. Users may be given the option to upload/stream/share their self-created advertisements for viewing by other users of the app and/or by users of other apps (such as social media apps) Users may be provided with rewards (e.g., discounts, free tickets, monetary rewards, etc.) for creating and uploading/streaming/sharing their self-created advertisements. Such rewards may be determined in part by the popularity of the self-created advertisement to outside viewers, such as where a user is provided with increased rewards responsive to that user's self-created advertisement being more popular on social media (e.g., in terms of viewers, etc.).
3. Calls to Action: An app of the invention may be configured to enable the creation of so-called “calls to action” (CTAs) that appear in the images/videos/overlays, such as at the end of video overlays. Such CTAs can direct app users to take specific actions, such visiting a website, making a purchase, making a donation, downloading an app, etc. Such CTAs may be provided for specific venues and/or specific paintings/displays/image that relate to the CTA, such as where a museum is dedicated to environmental matters and the CTA relates to environmental awareness.
4. Embedded Ads: Advertisers may be able to embed their ads directly into photos and/or videos, such as images and/or videos used in the overlays, and/or in photos/videos captured and shared by users. This can allow non-intrusive advertising that blends naturally with user-generated content. For example, an advertiser's business and/or product name may be subtly embedded into an image of a painting frame. Note that embedded ads may be formatted via the system to appear in a style that matches the photos/videos/paintings/venue etc. For example, in a museum of art by a particular artist, ads may be provided in a style used by that artist. Ads may even be presented as stand-alone paintings overlaid via augmented reality onto gallery walls that are in bare in real life.
5. Sponsored Filters and Effects: Advertisers may create custom Augmented Reality filters and effects that users can apply to their photos and videos. Such branded elements may enhance user creativity while promoting the advertiser's message. For example, advertiser-related effects may be added to a user's “native” video as shown on the user's smart phone screen, such as video (e.g., animated) elements relating to the advertiser's products. Examples include animated characters that move across the augmented reality view on smart phone screen, etc.
6. Geotargeted Ads: The app may use geolocation data to deliver ads specific to a user's location. This feature may allow businesses to reach potential customers who are nearby, increasing the relevance and effectiveness of the advertisements. For example, a restaurant may use the app to deliver ads to users visiting museums and other venues that are in physical proximity to the restaurant.
7. Interactive 3D Models: The app may be configured so that advertisers can embed interactive 3D models of their products within the augmented reality experiences. Users can interact with these models via the app, such as viewing the models from different angles, moving the models (e.g., rotating the model and/or relocating the model within a room). Users may be also able to obtain detailed product information via the app.
8. Augmented Reality Games and Challenges: The app may include AR-based games and challenges sponsored by brands. Users can engage with the brand by participating in these activities, with discounts and/or other rewards as incentives. The system may provide one or more games and/or challenges for selection by an advertiser, with those selected games/challenges then provided to users (e.g., via download) via the app. the games/challenges may include images/videos/other references to advertiser's products. The selected games/challenges may be customized for particular advertisers.
9. Event-Based Advertising: The app may be adapted to provide advertising partnerships with events, such as concerts, sports events, and festivals, to provide AR experiences that include event-specific advertising. This exclusive content may be accessible only during the event, creating unique and engaging marketing opportunities.
10. Personalized Ads: The app may use artificial intelligence to analyze behavior and preferences, delivering personalized ads. This targeted advertising approach increases relevance and user engagement.
11. Branded AR Portals: Advertisers can create AR portals that users can enter to experience branded virtual environments. Such portals may offer themed experiences or virtual stores, enhancing brand immersion.
12. Social Sharing Incentives: The app may encourage users to share their AR experiences and/or AR creations on social media by offering rewards (e.g., discounts) from advertisers. This feature may increase user engagement and brand visibility.
13. Story Integration: Advertisers can use the app to integrate their ads into user-generated stories. Sponsored story templates or themes may be used that allow brands to become a natural part of the user experience. The system/host can provide the templates (e.g., via a host memory), with the advertiser selecting a desired template and filling in the “blank” portions thereof (e.g., adding advertiser logo, adding images/video of the advertiser products, selecting colors and/or other theme elements of the template, etc. er theme elements of the template, etc. Such sponsored story templates/themes may include advertiser logos, brand colors, product images, etc., which may be played over the user video, at the bottom and/or top and/or sides of the video, etc.
14. Ad Placement in AR Worlds: The app may include AR worlds or environments where advertisers can place virtual billboards or posters. These placements may blend seamlessly into the AR space, providing subtle yet effective advertising. The virtual billboards/posters may be generated using AI to be in a style appropriate for the particular AR space.
15. In-App Purchases for Ad-Free Experience: Users can make in-app purchases to remove advertisements while still accessing premium AR content sponsored by brands. This feature offers a balance between monetization and user satisfaction.
16. AR Coupons and Promotions: The app may distribute AR coupons or promotional codes that users can scan with their smart phones to receive discounts or special offers. This feature enhances user engagement and drives sales for advertisers.
17. Dynamic Product Placement: The app may implement dynamic product placement within AR experiences, where specific products appear in relevant contexts based on user interactions. This context-sensitive advertising increases relevance and effectiveness. For example, an advertiser may request that a particular advertiser product, such as a soda can, is overlaid into the AR view, such as where the product is inserted into the background of the AR view.

Note that each element of each embodiment and its respective elements disclosed herein can be used with any other embodiment and its respective elements disclosed herein.

All dimensions listed are by way of example, and devices according to the invention may have dimensions outside those specific values and ranges. The dimensions and shape of the device and its elements depend on the particular application.

Unless otherwise noted, all technical and scientific terms used herein have the same meaning as commonly understood by one of ordinary skill in the art to which this disclosure belongs. In order to facilitate review of the various embodiments of the disclosure, the following explanation of terms is provided:

The singular terms “a”, “an”, and “the” include plural referents unless context clearly indicates otherwise. The term “or” refers to a single element of stated alternative elements or a combination of two or more elements, unless context clearly indicates otherwise.

The term “includes” means “comprises.” For example, a device that includes or comprises A and B contains A and B, but may optionally contain C or other components other than A and B. Moreover, a device that includes or comprises A or B may contain A or B or A and B, and optionally one or more other components, such as C.

The term “subject” refers to both human and other animal subjects. In certain embodiments, the subject is a human or other mammal, such as a primate, cat, dog, cow, horse, rodent, sheep, goat, or pig. In a particular example, the subject is a human patient.

Although methods and materials similar or equivalent to those described herein can be used in the practice or testing of the present disclosure, suitable methods and materials are described below. In case of conflict, the present specification, including terms, will control. In addition, the materials, methods, and examples are illustrative only and not intended to be limiting.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein, and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

In view of the many possible embodiments to which the principles of the disclosed invention may be applied, it should be recognized that the illustrated embodiments are only examples of the invention and should not be taken as limiting the scope of the invention. Rather, the scope of the invention is defined by the following claims. We therefore claim as our invention all that comes within the scope and spirit of these claims.

What is claimed is:

1. A system configured to display video content, the system comprising:
an electronic device such as a smart phone, comprising a camera, a screen, a memory, and a WIFI or other connection to a network such as the internet/cloud, wherein the smart phone is adapted to present a live action view, via the camera, onto the screen;
a mobile app configured for installation on the electronic device, wherein the mobile app is adapted to:
digitally overlay a first video onto or adjacent a live-action view of a first image when said first image is presented on the screen of the electronic device, wherein said digital overlay is responsive to the camera viewing a scannable code;
and
a remote server communicatively coupled to the mobile device via a network, the remote server adapted to:
maintain a code catalog of one or more scannable codes and one or more formatted videos, the one or more scannable codes comprising a first scannable code associated with the first video;
store one or more formatted videos, the one or more formatted videos comprising the first video;
identify the first video from the one or more formatted videos; and
download the first video to the electronic device.

2. The system of claim 1, wherein the mobile app is further adapted to:
prompt a user to select the first image from one or more still images; and/or
prompt a user to select the first video from one or more videos.

3. The system of claim 2, wherein the electronic device is further adapted to:
store the one or more images in the memory of the electronic device; and/or
store the one or more videos in the memory of the electronic device.

4. The system of any of the prior claims, wherein the mobile app is further adapted to:
compress the first video into a desired format to thereby create a first formatted video.

5. The system of claim 1, wherein the remote server is adapted to generate at least one of the one or more scannable codes maintained in the code catalog.

6. The system of claim 1, wherein the mobile app is adapted to generate at least one of the one or more scannable codes maintained in the code catalog.

7. The system of claim 1, the mobile app is adapted to compress the first video into a desired format.

8. The system of claim 1, wherein the mobile app is adapted to modify a shape and size of the first video to correspond to changes in the shape and size of the first image as displayed in live-action on the screen of the electronic device.

9. The system of claim 1, wherein the mobile app is adapted to match the shape and size of the first video to the shape and size of the first image in live-action on the screen of the electronic device.

10. The system of claim 1, wherein the first image is a still image from the first video.

11. A method for displaying video content, the method comprising:
providing one or more images;
providing one or more videos;
selecting a first image from the one or more images;
selecting a first video to associate with the first image, wherein the first video is selected from the one or more videos;
compressing the first video into a desired format to thereby create a first formatted video;
transmitting the first formatted video to a remote server;
storing the first formatted video on the remote server;
generating a first scannable code, or recognizing all or a portion of the first image as a first scannable code using image recognition software;
associating information of the first scannable code with the first formatted video.

12. The method of claim 11, comprising the further steps of:
presenting the first scannable code to a user for scanning by the user via a smartphone or other electronic device having a camera;
providing information on the first scannable code via the smartphone to the remote server;
identifying the first formatted video using the information of the first coded image provided to the remote server;
downloading first formatted video from the remote server to the smart phone;
providing a live video of the first image on the smart phone screen using the smart phone camera, the live video including a live video feed of the first image;
overlaying the first formatted video onto the live video feed of the first image as depicted on the screen of the electronic device.

13. The method of claim 12, wherein overlaying the first formatted video onto the live video feed of the first image comprises matching the shape and size of the first formatted video to the shape and size of the live video of the first image.

14. The method of claim 12 or 13, wherein overlaying the first formatted video onto the live video feed of the first image comprises real-time modifying of the shape and size of the first formatted video to correspond to real-time changes in the shape and size of the first image as seen in the live video feed.

15. The method of claim 11, further comprising:
designating the first formatted video as public or private; and
limiting access to a first formatted video designated as private.

16. The method of claim 11, wherein the first image is a still image from the first video.

17. The method of claim 12, wherein overlaying the first formatted video onto the live video feed of the first image comprises changing the first formatted video shape and size as viewed on the screen, wherein changing the first formatted video shape and size corresponds to changes in the shape and size of the first image as seen on the live video feed.

18. The method of claim 12, wherein the first formatted video size is larger in at least one of width or height or in both width and height than the first image as viewed on the screen so that in overlay the first formatted video extends beyond edges of the first image.

19. The method of claim 12, wherein the first formatted video size is smaller in at least one of width or height or in both width and height than the first image as viewed on the screen so that in overlay the first formatted video the height and/or width of the first formatted video is within edges of first image.

20. The method of claim 11, wherein combining the first scannable code with the first image comprises:
preparing a physical printout of the scannable code; and
securing the physical printout of the scannable code to a physical print of the first image.
